(19) United States
(12) Patent Application Publication
(10) Pub. No.: US 2024/0411313 A1
(43) Pub. Date: Dec. 12, 2024

(54) DYNAMIC BOUNDARIES FOR LOGISTICS CONTROL

(71) Applicant: Deere & Company, Moline, IL (US)

(72) Inventors: Nathan R. VANDIKE, Geneseo, IL (US); Corey A. AKERS, Bettendorf, IA (US); Federico PARDINA-MALBRAN, Fort Collins, CO (US); Stephen R. CORBAN, Geneseo, IL (US)

(21) Appl. No.: 18/333,295

(22) Filed: Jun. 12, 2023

(51) Int. Cl. G05D 1/10

(52) U.S. Cl. CPC G05D 1/10

(57) ABSTRACT

Data is obtained by a worksite operation system. The data includes machine sensor data indicative of one or more characteristics of a mobile machine operating at a worksite. The worksite operation system generates, based on the obtained data, a dynamic boundary output indicative of a predictive boundary of the mobile machine at a location along a predictive path of the mobile machine at the worksite. The worksite operation system generates a control signal based on the dynamic boundary output.

### FIELD OF THE DESCRIPTION

The present description relates to worksite operations. More specifically, the present description relates to controlling logistics of worksite operations.

### BACKGROUND

There are a wide variety of different types of worksite operations. Some such worksite operations include agricultural worksite operations, construction worksite operations, turf management worksite operations, forestry worksite operations, as well as various other types of worksite operations. Worksite operation architectures can include a variety of different mobile machines that operate at the worksite to perform a worksite operation. The logistics of a worksite operation, including path planning (or route planning) of the mobile machines, can be coordinated to ensure efficient and safe performance of the worksite operation.

The discussion above is merely provided for general background information and is not intended to be used as an aid in determining the scope of the claimed subject matter.

### SUMMARY

Data is obtained by a worksite operation system. The data includes machine sensor data indicative of one or more characteristics of a mobile machine operating at a worksite. The worksite operation system generates, based on the obtained data, a dynamic boundary output indicative of a predictive boundary of the mobile machine at a location along a predictive path of the mobile machine at the worksite. The worksite operation system generates a control signal based on the dynamic boundary output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of one example worksite operation system architecture.

FIG. 2 is a block diagram of one example worksite operation system architecture.

FIG. 3 is a block diagram of one example logistics system.

FIGS. 4A-4B are pictorial illustrations showing example dynamic boundary outputs.

FIGS. 5A-5B are pictorial illustrations showing examples of dynamic boundary outputs with confidence bands.

FIG. 6 is a pictorial illustration showing one example three-dimensional dynamic boundary output.

FIG. 7 is a pictorial illustration of one example logistics output in the form of a worksite map.

FIG. 8 is a flow diagram illustrating one example of operation of a worksite operation system architecture in generating logistics output(s) and control based thereon.

FIG. 9 is a block diagram showing one example of items of a worksite operation system architecture in communication with a remote server architecture.

FIGS. 10-12 show examples of mobile devices that can be used in a worksite operation system architecture.

FIG. 13 is a block diagram showing one example of a computing environment that can be used in a worksite operation architecture.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

A worksite operation system architecture can include a variety of different mobile machines that operate at the worksite to perform a worksite operation. The mobile machines can be coordinated in order to ensure efficient and safe performance of the worksite operation. For example, the logistics of the worksite operation, including the path (or route) planning of the various mobile machines, can be coordinated such that the mobile machines operate in the desired areas at the desired times as well as to ensure that the mobile machines do not undesirably interfere with one another. Route planning often takes into account boundaries and obstacles at the worksite. Many of the boundaries and obstacles are fixed (or relatively fixed) such that their location is unlikely to change during the course of the worksite operation. However, other objects, such as the mobile machines at the worksite, often change location throughout the course of the worksite operation. For example, the mobile machines may travel from one spot to another or the space that the mobile machines take up may change throughout an operation, or both. It can be difficult to accurately control the logistics of an operation given the dynamic locations and boundaries of the mobile machines.

The present discussion proceeds, in some examples, with respect to systems and methods that generate dynamic boundary outputs for one or more items, such as one or more mobile machines, in a worksite operation architecture. A dynamic boundary output indicates a location and boundary of a mobile machine at one or more points in time. For example, a dynamic boundary output can include a historical portion that indicates one or more timestamped historical locations and historical boundaries of a mobile machine, a current portion that indicates a current location and current boundary of the mobile machine at a current time, and a future portion that indicates one or more timestamped predictive future locations and predictive future boundaries of a mobile machine. Additionally, a dynamic boundary output can include a confidence band. The confidence band can indicate an extension of the location or boundary, or both, of a mobile machine based on a confidence with which the dynamic boundary output is generated. A respective dynamic boundary output can be generated for each of one or more mobile machines in a worksite operation architecture. Various data including, but not limited to, georeferenced worksite data (such as worksite maps), mobile machine sensor data, mobile machine configuration data, and mobile machine operation data can be utilized in generating the dynamic boundary outputs. The dynamic boundary outputs can be utilized to coordinate logistics of the worksite operation including route (or path) planning of one or more of the mobile machines. The planned route(s) (or paths) can be used to control the one or more mobile machines. Additionally, or alternatively, the dynamic boundary outputs can be presented to operator(s) or user(s).

It will be noted that while the various examples discussed herein proceed in the context of agricultural worksite operation architectures, agricultural worksite operations, and mobile agricultural machines, the systems and methods described herein are applicable to and can be used in various other worksite operation architectures, worksite operations, and mobile machine. For example, but not by limitation, the systems and method described herein are applicable to and can be used in construction worksite operation architectures, construction worksite operations, mobile construction machines, forestry worksite operation architectures, forestry worksite operations, mobile forestry machines, turf management worksite operation architectures, turf management worksite operations, mobile turf management machines, as well as various other worksite operation architectures, worksite operations, and mobile machines.

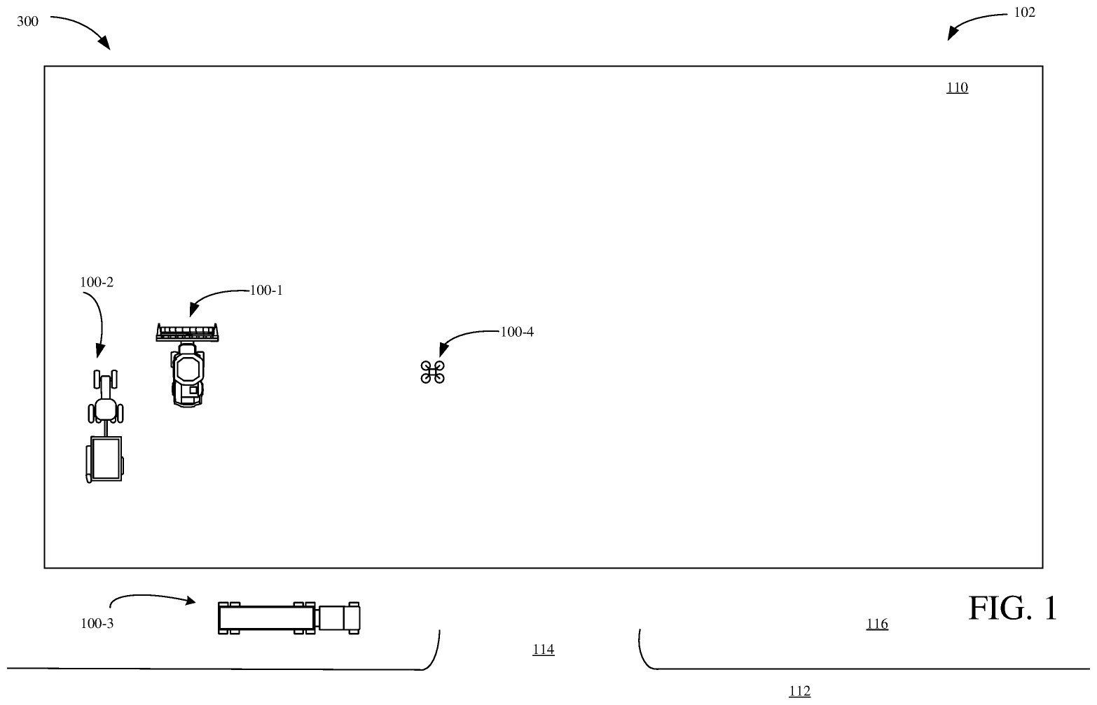

FIG. 1 is a pictorial illustration of one example of a worksite operation system architecture 300 at a worksite 102. As illustrated in FIG. 1, worksite operation architecture 300 includes a plurality of mobile machines 100. As illustrated in FIG. 1, worksite 102 includes agricultural field 110, road 112, field entrance 114, and headlands 116. Mobile machines 100, shown as material filling machine (or harvester) 100-1, material receiving machine (or towing vehicle and towed grain cart) 100-2, material receiving machine (or semi and semi-trailer) 100-3, and aerial vehicle (or unmanned aerial vehicle (UAV)) 100-4, are performing a harvesting operation at worksite 102.

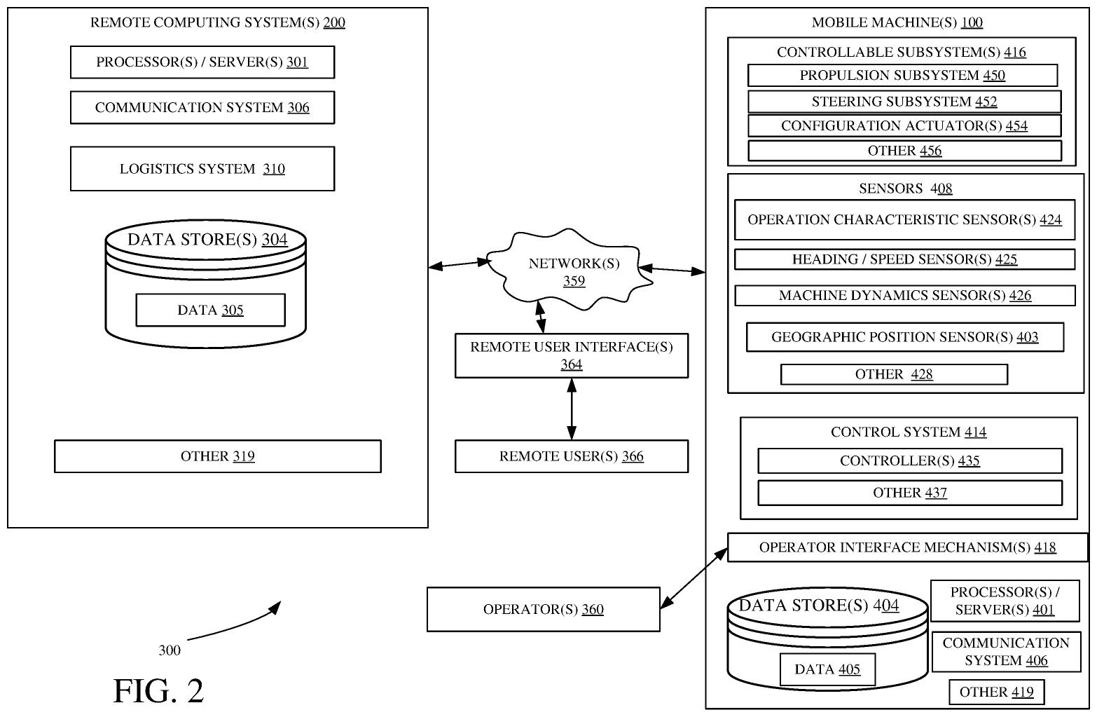

FIG. 2 is a block diagram of worksite operation system architecture 300 (also referred to herein as worksite operation system) in more detail. FIG. 2 shows that worksite operation system 300 includes one or more mobile machines 100, one or more remote computing systems 200, one or more remote user interfaces 364, and one or more networks 359. As illustrated in FIG. 1, mobile machines 100 can include ground-based mobile machines or aerial mobile machines, such as unmanned aerial mobile machines. Mobile machines 100, themselves, illustratively includes one or more processors or servers 401, one or more data stores 404, communication system 406, one or more sensors 408, control system 414, one or more controllable subsystems 416, one or more operator interface mechanisms 418, and can include various other items and functionality 419 as well. Remote computing systems 200, as illustrated, include one or more processors or servers 301, one or more data stores 304, communication system 306, logistics system 310, and can include various other items and functionality 319.

Data stores 304 or data stores 404, or both, store a variety of data (generally indicated as data 305 and data 405 respectively), some of which will be described in more detail herein. For example, data 305 or data 405, or both, can include, among other things, georeferenced worksite data, such as worksite maps, mobile machine sensor data generated by sensors 408, mobile machine configuration data, mobile machine operation data, as well as a variety of other data. Additionally, data 305 can include computer executable instructions that are executable by one or more processors or servers 301 to implement other items or functionalities of worksite operation system 300. Additionally, data 405 can include computer executable instructions that are executable by one or more processors or servers 401 to implement other items or functionalities of worksite operation system 300. It will be understood that data stores 304 or data stores 404, or both, can include different forms of data stores, for instance one or more of volatile data stores (e.g., Random Access Memory (RAM)) and non-volatile data stores (e.g., Read Only Memory (ROM), hard drives, solid state drives, etc.).

Sensors 408 can include operation characteristic sensors 424, heading/speed sensors 425, machine dynamics sensors 426, geographic position sensors 403, and can include various other sensors 428 as well. The sensor data generated by sensors 408 can be communicated to remote computing systems 200. Control system 414, itself, can include one or more controllers 435 for controlling various other items of mobile machine 100, and can include other items 437 as well. Controllable subsystems 416 can include propulsion subsystem 450, steering subsystem 452, and can include various other subsystems 456 as well.

Operation characteristic sensors 424 detect various operating characteristics of a mobile machine. Operation characteristic sensors 424 can include position/deployment sensors (e.g., imaging systems, such as one or more cameras, hall effect sensors, potentiometers, encoders, transducers, ranging (time of flight) sensors, operator/user input sensors, etc.) that detect the position or deployment, or both, of various items of mobile machine 100. For example, where mobile machine 100 is an agricultural harvester, operation characteristic sensors 424 may detect the position or deployment, or both, of various components of the agricultural harvester such as the position or deployment, or both, of an unloading auger assembly though which material is transferred from the harvester to another machine or location, the position or deployment, or both, of a grain tank cover, the position or deployment, or both, of an associated UAV which may be wirelessly coupled and physically coupled (e.g., tethered) to the a mobile machine 100 or may be only wirelessly coupled to the mobile machine 100, or the position or deployment, or both, of a header of the harvester. These are merely some examples. Other types of mobile machines may have other types of components, the position or deployment, or both, of which can be detected by operation characteristic sensors 424. It will be understood that the position or deployment, or both, of a component of a mobile machine 100 can affect the space which the mobile machine 100 occupies and thus the effective boundary of the mobile machine 100.

Heading/speed sensors 425 detect a heading characteristic (e.g., travel direction) or speed characteristics (e.g., travel speed, acceleration, deceleration, etc.), or both, of a mobile machine 100. This can include sensors that sense the movement (e.g., rotation) of ground-engaging elements (e.g., wheels or tracks) or the movement of other elements (e.g., propeller blades), or movement of components coupled to the ground engaging elements or other elements, or can utilize signals received from other sources, such as geographic position sensors 403. Thus, while heading/speed sensors 425 as described herein are shown as separate from geographic position sensors 403, in some examples, machine heading/speed is derived from signals received from geographic position sensors 403 and subsequent processing. In other examples, heading/speed sensors 425 are separate sensors and do not utilize signals received from other sources.

Machine dynamics sensors 426 detect machine dynamics characteristics (e.g., pitch, roll, and yaw) of a mobile machine. Machine dynamics sensors 426 can include inertial measurement units, accelerometers, gyroscopes, magnetometers, inclinometers, as well as various other sensors.

Geographic position sensors 403 illustratively sense or detect the geographic position or location of a mobile machine 100. Geographic position sensors 403 can include, but are not limited to, a global navigation satellite system (GNSS) receiver that receives signals from a GNSS satellite transmitter. Geographic position sensors 403 can also include a real-time kinematic (RTK) component that is configured to enhance the precision of position data derived from the GNSS signal. Geographic position sensors 403 can include a dead reckoning system, a cellular triangulation system, or any of a variety of other geographic position sensors.

Sensors 408 can also include various other types of sensors 428.

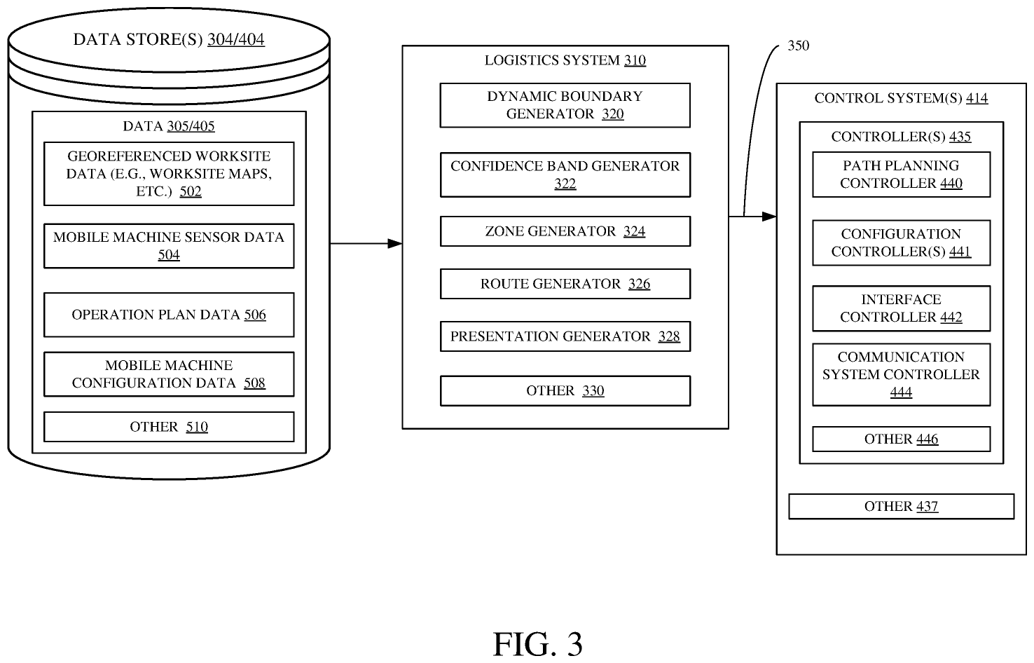

Control system 414 can include a variety of controllers 435, such as a communication system controller to control communication system 406, such as to send information to various other items of worksite operation system 300 or to obtain information from various other items of worksite operation system 300, or both. Controllers 435 can also include one or more configuration controllers to control one or more configuration actuators 454 to control a configuration (e.g., a position or orientation, or both) of one or more components of mobile machine 100. Controllers 435 can also include a path planning controller to control steering subsystem 452 to control the heading of a mobile machine 100 and to control propulsion subsystem 450 to control a travel speed, acceleration, and/or deceleration of a mobile machine 100. Controllers 435 can also include an operator interface controller to control operator interface mechanisms 418 to provide indications, such as displays, alerts, notifications, as well as various other outputs. In other examples, one controller 435 may control one or more items of a mobile machine 100. Additionally, it will be understood that controllers 435 can include or be implemented by one or more processors or servers 401. Control system 414 will be shown in more detail in FIG. 3.

Communication system 406 is used to communicate between components of a mobile machine 100 or with other items of worksite operation system 300, such as remote computing systems 200 or other mobile machines 100, or both. Communication system 406 can include one or more of wired communication circuitry and wireless communication circuitry, as well as wired and wireless communication components. In some examples, communication system 406 can be a cellular communication system, a system for communicating over a wide area network or a local area network, a system for communicating over a controller area network (CAN), such as a CAN bus, a system for communication over a near field communication network, or a communication system configured to communicate over any of a variety of other networks. Communication system 406 can also include a system that facilitates downloads or transfers of information to and from a secure digital (SD) card or a universal serial bus (USB) card, or both. Communication system can utilize network 359. Networks 359 can be any of a wide variety of different types of networks such as the Internet, a cellular network, a wide area network (WAN), a local area network (LAN), a controller area network (CAN), a near-field communication network, or any of a wide variety of other networks or communication systems.

Communication system 306 is used to communicate between components of the remote computing system 200 or with other items of worksite operation system 300, such as mobile machines 100. Communication system 306 can include one or more of wired communication circuitry and wireless communication circuitry, as well as wired and wireless communication components. In some examples, communication system 306 can be a cellular communication system, a system for communicating over a wide area network or a local area network, a system for communicating over a controller area network (CAN), such as a CAN bus, a system for communication over a near field communication network, or a communication system configured to communicate over any of a variety of other networks. Communication system 306 can also include a system that facilitates downloads or transfers of information to and from a secure digital (SD) card or a universal serial bus (USB) card, or both. In communicating with other items of worksite operation system 300, communication system can utilize networks 359.

FIG. 2 also shows that remote computing systems 200 include logistics system 310. Logistics system 310 generates one or more dynamic boundary outputs that are useable in the control of one or more mobile machines 100 based on various data (e.g., data 305 or data 405, or both). Logistics system 310 and dynamic boundary outputs will be discussed in greater detail further below.

FIG. 2 also shows remote users 366 interacting with mobile machines 100 and remote computing systems 200 through user interfaces mechanisms 364 over networks 359. In some examples, user interface mechanisms 364 may include joysticks, levers, a steering wheel, linkages, pedals, buttons, wireless devices (e.g., mobile computing devices, etc.), dials, keypads, user actuatable elements (such as icons, buttons, etc.) on a user interface display device, a microphone and speaker (where speech recognition and speech synthesis are provided), among a wide variety of other types of control devices. Where a touch sensitive display system is provided, the users 366 may interact with user interface mechanisms 364 using touch gestures. These examples described above are provided as illustrative examples and are not intended to limit the scope of the present disclosure. Consequently, other types of user interface mechanisms 364 may be used and are within the scope of the present disclosure.

FIG. 2 also shows that one or more operators 360 may operate mobile machines 100. The operators 360 interact with operator interface mechanisms 418. In some examples, operator interface mechanisms 418 may include joysticks, levers, a steering wheel, linkages, pedals, buttons, wireless devices (e.g., mobile computing devices, etc.), dials, keypads, user actuatable elements (such as icons, buttons, etc.) on a user interface display device, a microphone and speaker (where speech recognition and speech synthesis are provided), among a wide variety of other types of control devices. Where a touch sensitive display system is provided, the operators 360 may interact with operator interface mechanisms 418 using touch gestures. These examples described above are provided as illustrative examples and are not intended to limit the scope of the present disclosure. Consequently, other types of operator interface mechanisms 418 may be used and are within the scope of the present disclosure.

Remote computing systems 200 can be a wide variety of different types of systems, or combinations thereof. For example, remote computing systems 200 can be in a remote server environment. Further, remote computing systems 200 can be remote computing systems, such as mobile devices, a remote network, a farm manager system, a vendor system, or a wide variety of other remote systems. In one example, mobile machines 100, can be controlled remotely by remote computing systems 200 or by remote users 366, or both.

In some examples, one or more of the components shown in FIG. 2 as being disposed on mobile machines 100 can be located elsewhere, such as at remote computing systems 200. Similarly, in some examples, one or more of the components shown in FIG. 2 as being disposed on remote computing systems 200 can be located elsewhere, such as on mobile machines 100. Thus, it will be understood that the items in worksite operation system 300 can be distributed in various ways, including ways that differ from the example shown in FIG. 2.

FIG. 3 is a block diagram of portions of worksite operation system 300, shown in FIG. 2, in more detail. FIG. 3 also shows the information flow among the various components shown. As illustrated, logistics system 310 obtains (e.g., retrieves or receives) data 305 from data store 304 or data 405 from data store 404 or both, and generates one or more logistics outputs 350 which are obtained by one or more control systems 414 and can be used by each control system 414 to control a corresponding mobile machine 100. Data 305 or data 405, or both, can include georeferenced worksite data 502, mobile machine sensor data 504, operation plan data 506, mobile machine configuration data 508, as well as various other data 510.

Georeferenced worksite data 502 can include georeferenced characteristics of a worksite at which a worksite operation is taking (or is to take) place. Georeferenced worksite data 502 can be in the form of worksite maps. Georeferenced worksite data 502 can indicate various characteristics of the worksite including, but not limited to, items and the location of items of the worksite, such as the location of a field, the location of headlands, the location of a road, the location of a field entrance, the location of field boundaries, the location of fixed obstacles, as well as various other information. Georeferenced worksite data 502 can also indicate topographical characteristics of the worksite such as elevation and slope of the worksite at different locations across the worksite. These are merely some examples of the characteristics that can be indicated by georeferenced worksite data 502. Georeferenced worksite data 502 can be used by logistics system 310 to generate one or more logistics outputs 350. For instance, georeferenced worksite data 502 can be used to determine current location and boundary of the mobile machine 100 as well as to predict a future path and future boundaries of the mobile machine 100. For example, georeferenced worksite data 502 indicating a location of crop rows (or crop plants) may be useful in predicting a future path of a mobile machine 100, such as a harvester 100-1. In another example, georeferenced worksite data 504 indicating characteristics of the terrain of the worksite (e.g., slope, surface roughness, etc.) may be used to predict future machine boundaries as the characteristics of the terrain can have an effect on the boundary of the machine (e.g., cause the machine to pitch or roll and thus change location of its boundary). These are merely some examples of how georeferenced worksite data 504 can be used by logistics system 310 to generate logistics outputs 350.

Mobile machine sensor data 504 can include the sensor data generated by sensors 408, or the values indicated by the sensor data generated by sensors 408, or both. This can include mobile machine location sensor data (or mobile machine location values), mobile machine heading sensor data (or heading values), mobile machine speed sensor data (or mobile machine speed values), mobile machine dynamics sensor data (or mobile machine dynamics values), and mobile machine operation characteristics sensor data (or mobile machine operation characteristics values). The mobile machine operation characteristics sensor data (or mobile machine operation characteristics values) can indicate the position and deployment of various components of the mobile machines 100. These are merely some examples of mobile machine sensor data 504. The machine sensor data 504 can be used by logistics system 310 to generate one or more logistics outputs 350. For instance, the historical boundaries and locations and the current location and boundary of a mobile machine 100 can be determined based on machine sensor data 504. Additionally, machine sensor data 504 can be used to generate a predictive boundary and predictive path of the mobile machine 100. For instance, the sensed current heading and sensed current speed of the mobile machine 100 can be used to predict a future path of the mobile machine as well as times at which the mobile machine 100 will arrive at locations along the predictive future path. These are merely some examples of how machine sensor data 504 can be used by logistics system 310 to generate logistics outputs 350.

Operation plan data 506 can include data that indicates planned or prescribed operational data for the mobile machines 100. Operation plan data 506 can include planned or prescribed routes of the mobile machines 100, planned or prescribed operating parameters, such as planned or prescribed speeds, as well as planned or prescribed locations for various operations (such as planned or prescribed locations for material transfer operations). These are merely some examples of operation plan data 506. The operation plan data 506 can be used by logistics system 310 to generate one or more logistics outputs 350. For instance, the current location and boundary of a mobile machine 100 can be determined based on operation plan data 506 which might indicate where the mobile machine 100 ought to be at a given time and what the mobile machine 100 ought to be doing. Additionally, operation plan data 506 can be used to generate a predictive boundary and predictive path of the mobile machine 100. For instance, the planned or prescribed route and heading of the mobile machine 100 can be used to predict a future path of the mobile machine as well as times at which the mobile machine 100 will arrive at locations along the predictive future path. Additionally, planned or prescribed operations and their locations in operation plan data May be used to generate a predictive boundary of the mobile machine 100. These are merely some examples of how operation plan data 506 can be used by logistics system 310 to generate logistics outputs 350.

Mobile machine configuration data 508 can include data that indicates the type, dimensions, and capabilities of mobile machines 100. Additionally, mobile machine configuration data 508 can include data that indicates how each mobile machine 100 is being operated, for example, whether a mobile machine 100 is being operated by a human operator or by an automatic control system. Mobile machine configuration data 508 can be used by logistics system 310 to generate one or more logistics outputs 350. For instance, the machine dimensions of a mobile machine 100 may be used in generating boundaries corresponding to the mobile machine 100. An indication of how the mobile machine 100 is being operated (i.e., by a human operator or by an automatic control system) may be used in the generation of confidence bands (e.g., wider confidence band where the operator is human or narrower when the operator is an automated control system) as well as in the generation of dynamic boundaries. For instance, the type of operator may determine weight or selection of given data to be used in predicting a future boundary or a future path of the machine. For example, where the mobile machine 100 is operated by a human, logistics system 310 may select or give more weight to machine sensor data 504 whereas if the operator is an automated control system, logistics system 310 may select or give more weight to operation plan data 506, These are merely some examples of how mobile machine configuration data 508 can be used by logistics system 310 to generate logistics outputs 350.

As illustrated in FIG. 3, logistics system 310 includes dynamic boundary generator 320, confidence band generator 322, zone generator 324, route generator 326, presentation generator 328, and can include various other items 330.

Dynamic boundary generator 320 generates and outputs a dynamic boundary for each of the one or more mobile machines 100 operating in the worksite operation based on data 305 or 405, or both. A dynamic boundary output can include a future predictive portion, a current portion, and a historical portion. The future predictive portion indicates a predictive travel path of a mobile machine 100 as well as a predictive boundary of the mobile machine 100 at one or more locations along the predictive travel path. Each location along the predictive travel path can be timestamped to indicate a time at which the mobile machine 100 is predicted to be at that location. The current portion indicates a current location and current boundary of the mobile machine 100. The historical portion indicates a historical travel path of the mobile machine 100 as well as a historical boundary of the mobile machine 100 at one or more locations along the historical travel path. Each location along the historical travel path can be timestamped to indicate the time at which the mobile machine was at that location.

The boundary of the machine, as indicated by a dynamic boundary output, can be multidimensional, including three dimensional. Thus, the dynamic boundary output can indicate two or more of the width, length, and height of a mobile machine 100 (or provide two or more of an x, y, and z value). Each given time stamp in the dynamic boundary output may have a respective width, length, and height (or x, y, and z values) that indicate the boundary (predictive or measured) of a mobile machine 100 at that time stamp. In one example, the dynamic boundary output may be in a presentable form such as a presentable generalized shape, such as a polygon or cuboid, the dimensions of which correspond to the greatest dimension in any given dimension, for instance the length may correspond to the greatest length of the mobile machine 100, the width may correspond to the greatest width of the mobile machine 100, and the height may correspond to the greatest height of the mobile machine 100. In another example, the boundary output may be in a presentable form such as a presentable contoured shape, contoured to more precisely reflect the dimension of the mobile machine 100 at the corresponding location on the mobile machine. For instance, the presentable dynamic boundary output may be contoured, to more precisely match the mobile machine 100, such that the width of the presentable dynamic boundary output varies along the length or the height, or both, of the presentable dynamic boundary output, such that the length of the presentable dynamic boundary output varies along the width or the height, or both, of the presentable dynamic boundary output, or such that the height of the presentable dynamic boundary output varies along the width or the length, or both, of the presentable dynamic boundary output. In another example, the boundary output may be in a presentable form such as a set of values. For example, the presentable set of values may include two or more of width, length, and height values (or x, y, and z values) at each time stamp, for example. Such a set of example may comprise (T₁ (x₁, y₁, and z₁), T₂ (x₂, y₂, and z₂), . . . Tₙ (xₙ, yₙ, and zₙ) where x₁, y₁, and z₁ represent, respectively, the x (width), y (length), and z (height) values of the boundary of mobile machine 100 at T₁ (a first time), where x₂, y₂, and z₂ represent, respectively, the x (width), y (length), and z (height) values of the boundary of mobile machine 100 at T₂ (a second time), the set of values can include a respective x, y, and z value at each of a plurality of other times as represented by Tₙ (xₙ, yₙ, and zₙ). In addition to x, y, and z values at each of a plurality of times, the set can further include a respective geographic position value of the mobile machine at each of a plurality of times, such Tₙ (xₙ, yₙ, zₙ, and gₙ) where gₙ is the geographic position value(s) of the mobile machine 100 at the corresponding time Tₙ. It will be understood that gₙ can include the latitude, longitude, and altitude of the mobile machine 100. Of course, it will be understood that the dynamic boundary output need not be presented or be in presentable form and can instead be generated as values usable by other components of system 300, such as control system 414.

Confidence band generator 322 generates a confidence band that surrounds each dynamic boundary output generated by dynamic boundary generator 320. A confidence band effectively extends the area of the worksite to which the boundary of a mobile machine 100 corresponds. In some examples, the size of the confidence band can be a default size or preset size selected by an operator or user. In some examples, the size of a confidence band can vary with the confidence in the determined dynamic boundary (e.g., increase in size as confidence decreases and decrease in size as confidence increases). The confidence in the dynamic boundary can be based on the type of mobile machine 100 to which the dynamic boundary corresponds, the type of operator 360 (human or automatic control system) operating the mobile machine 100 to which the dynamic boundary corresponds, or the extent to which the operation of the mobile machine 100 to which the dynamic boundary corresponds is planned or prescribed. For instance, confidence may be relatively lower when a human operator is operating a mobile machine 100 as compared to an automatic control system. Similarly, confidence may be relatively lower when the mobile machine 100 is operating without a planned or prescribed operation plan as compared to when the mobile machine 100 is operating with a planned or prescribed operation plan. In another example, confidence may be relatively lower given the type of mobile machine, for instance, a harvester may have a relatively narrow confidence band, a grain semi may have a relatively narrow confidence band, a towed grain cart may have a moderate confidence band, and a farm manager utility vehicle may have a wide confidence band. It may be expected that certain types of machines may be more likely to vary in operation and thus there may be less confidence in their predicted boundaries and locations. In another example, the confidence band may vary in size the further away from the current position and boundary of the mobile machine. For example, there may be less confidence in a prediction that is further out in time or distance, or both, and thus the confidence band may be larger the further away from the current location and boundary of the mobile machine. These are merely some examples.

A confidence band may be output in presentable form, such as a presentable generalized shape. In another example, a confidence band may in a presentable form such as a set of values. For example, the presentable set of values may include location values indicative of locations at the worksite to which the confidence band corresponds for each of a plurality of timestamps. For instance, the set of values may include one or more latitude values, one or more longitude values, and one or more altitude values for each timestamp to indicate the area of the worksite to which the confidence band corresponds for each timestamp. Of course, it will be understood that the confidence band need not be presented or be in presentable form and can instead be generated as values usable by other components of system 300, such as control system 414.

Zone generator 324 generates permitted and restricted zones of the worksite based on one or more of the dynamic boundary outputs generated by dynamic boundary generator 320 or the confidence bands generated by confidence band generator 322, or both. Permitted zones are areas of the worksite surrounding the areas of the worksite to which a dynamic machine boundary and, in some examples, a corresponding confidence band correspond. Permitted zones are areas of the worksite in which a mobile machine 100 may travel and in which a mobile machine 100 May operate. Restricted zones are areas of the worksite in which travel or operation of a mobile machine 100 are either not permitted, or are otherwise restricted. Restricted zones may be areas of the worksite to which the dynamic machine boundary and, in some examples, a corresponding confidence band correspond. However, the restricted zone may be an area of the worksite that extends beyond the area of the worksite to which the dynamic machine boundary and, in some examples, a corresponding confidence band correspond or may be an area of the worksite that is only a portion of the area of the worksite which the dynamic machine boundary and, in some examples, a corresponding confidence band correspond. The permitted and restricted zones can be dynamic and can change with time. For example, an area of the worksite may be assigned as a restricted zone at one time or for a series of time and then be assigned as a permitted zone at another, later time or later series of time. Similarly, an area of the worksite may be assigned as a permitted zone at one time or for a series of time and then be assigned as a restricted zone at another, later time or later series of time.

A zone may be output in presentable form, such as a presentable generalized shape. In another example, a zone may in a presentable form such as a set of values. For example, the presentable set of values may include location values indicative of locations at the worksite to which the zone corresponds for each of a plurality of timestamps. For instance, the set of values may include one or more latitude values, one or more longitude values, and one or more altitude values for each timestamp to indicate the area of the worksite to which the zone corresponds for each timestamp. Of course, it will be understood that the zone need not be presented or be in presentable form and can instead be generated as values usable by other components of system 300, such as control system 414.

It will be understood that the dynamic boundaries, confidence bands, and zones can be presented in a variety of ways, including different visual characteristics to distinguish them from each other, such as different colors, patterns, shades, and transparencies. Distinct visual characteristics may be particularly useful where two or more of a dynamic boundary, a confidence band, and a zone are presented simultaneously. Similarly, different portions of a dynamic boundary (e.g., historical portion, current portion, and future predictive portion) may have different visual characteristics for purposes of distinction. Similarly, different portions of a confidence band (e.g., portion corresponding to current portion of dynamic boundary and portion corresponding to future predictive portion) may have different visual characteristics for purposes of distinction. Permitted and restricted zones may have different visual characteristics for purposes of distinction.

Route generator 326 generates routes for one or more of mobile machines 100 operating (or set to operate) at the worksite based on one or more of the dynamic boundary outputs generated by dynamic boundary generator 320, the confidence bands generated by confidence band generator 322, or the zones generated by zone generator 326.

Presentation generator 328 generates presentations (e.g., displays, haptic outputs, audible outputs, etc.) to be presented to an operator 360 or user 366, or both, based on one or more of the dynamic boundary outputs generated by dynamic boundary generator 320, the confidence bands generated by confidence band generator 322, the zones generated by zone generator 326, or the routes generated by route generator 326. A presentation can include one or more of a dynamic boundary of a mobile machine 100, a confidence band, a zone, or a route. A presentation can be presented via an interface mechanism such as to an operator 360 via an operator interface mechanism 418 or to a user 366 via a user interface mechanism 364, or both. In one example, presentation generator 328 can generate, as a presentation, a map of the worksite that includes one or more of a dynamic boundary, a confidence band, a zone, or a route, presented in the map, at their corresponding locations in the worksite.

As can be seen, logistics system 310 generates logistics outputs 350. Logistics outputs 350 can include one or more of one or more dynamic mobile machine boundaries generated and output by dynamic boundary generator 320, one or more confidence bands generated and output by confidence band generator 322, one or more zones generated and output by zone generator 324, one or more routes generated and output by route generator 326, or one or more displays generated and output by display generator 328.

The logistics outputs 350 are obtained by one or more control systems 414 and can be used as a basis for control of mobile machines 100 as well as other items of worksite operation system 300. As illustrated in FIG. 3, control system 414 includes path planning controller 440, one or more configuration controllers 441, interface controller 442, communication system controller 444, and can include various other controllers 446 as well.

Path planning controller 440 controls propulsion subsystem 450 to control a speed of mobile machine 100 and control steering subsystem 452 to control a heading of mobile machine 100 based on logistics outputs 350. In some examples, path planning controller 440 may control propulsion subsystem 450 and steering subsystem 452 to guide mobile machine 100 along a route generated by route generator 326. In other examples, path planning controller 440, itself, may generate a route for mobile machine based one or more of dynamic boundaries, confidence bands, or zones generated by logistics system 310 and output as logistics outputs 350 and then control propulsion subsystem 450 and steering subsystem 452 to guide mobile machine 100 along that route.

One or more configuration controllers 441 control one or more configuration actuators 454 to control a position or orientation, or both, of one or more items of mobile machine 100 based on logistics outputs 350. For instance, in some examples, the route of the mobile machine 100 need not vary, instead, only a position or orientation of a component of mobile machine 100 need vary. In some examples, both the route and the position or orientation, or both, of a component of the mobile machine 100 need vary. As an example, instead of, or in addition to adjusting the route of the mobile machine 100, control system 414 may control one or more configuration actuators 454 to adjust a position or orientation, or both, of a component of mobile machine 100, such as an unloading chute or spout, or both.

Interface controller 442 controls operator interface mechanisms 418 or remote user interface mechanisms 364, or both, to generate presentation(s) (e.g., displays, alerts, notifications, recommendations, etc.) based on logistics outputs 350. A presentation can include representations of one or more of dynamic boundaries, confidence bands, zones, or routes generated by logistics system 310 and output as logistics outputs 350. In another example, interface controller 442 controls operator interface mechanisms 418 or remote user interface mechanisms 364, or both, to generate presentations based on routes generated by path planning controller 440. In one example, a presentation can include a map of the worksite that includes display elements representing dynamic boundaries, confidence bands, zones, or routes in the map at their corresponding locations in the worksite. Additionally, the presentation can include display elements corresponding to the mobile machines 100 at their corresponding locations in the worksite. The mobile machine display elements may vary with and thus indicate the type of mobile machine 100.

Communication system controller 444 controls communication system 406 to send and receive data within mobile machine 100 and between mobile machine 100 and other items of worksite operation system 300 (e.g., via networks 359).

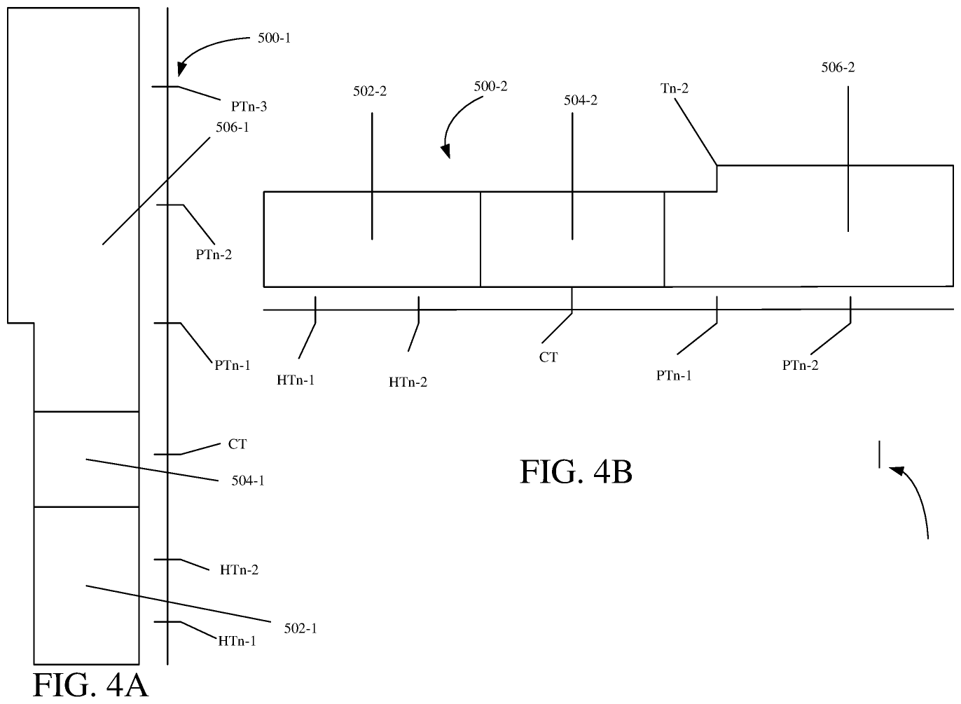

FIGS. 4A-4B are pictorial illustrations showing example logistics outputs 350 generated by logistics system 310. FIGS. 4A-4B shows that a logistics output 350 can include a dynamic boundary 500. As illustrated, a dynamic boundary 500 can include a historical portion 502, a current portion 504, and a future predictive portion 506. It will be understood that the examples shown in FIGS. 4A-4B illustrate examples of dynamic boundaries output by logistics system 310 in a presentable form (e.g., as a displayable element). In other examples, it will be understood that the dynamic boundaries output by logistics system 310 need not be in a presentable form such as the ones shown in FIGS. 4A-4B and can instead include timestamped values indicating the location and boundary of a mobile machine 100 at each of a plurality of different timestamps (e.g., a geographic position value and x, y, and z values at each time stamp).

FIG. 4A shows a top, pictorial view of an example dynamic boundary 500-1 that corresponds to a mobile machine 100, such as a mobile harvesting machine 100-1. As can be seen, dynamic boundary 500-1 includes a historic portion 502-1 that indicates timestamped (shown as historic timestamps HTₙ₋₁ and HTₙ₋₂), historic geographic positions and historic boundaries of the mobile machine 100 as well as the historic path of the mobile machine 100. Dynamic boundary 500-1 further includes a current portion 504-1 that indicates a timestamped (shown as current timestamp CT), current geographic position and current boundary of the mobile machine 100. Dynamic boundary 500-1 further includes a future predictive portion 506-1 that indicates timestamped (shown as predictive timestamps PTₙ₋₁, PTₙ₋₂, and PTₙ₋₃), future predictive geographic positions and future predictive boundaries of the mobile machine 100, as well as the future predictive path of the mobile machine 100. As can be seen in FIG. 4A, at predictive timestamp (or time) PTₙ₋₁ logistics system 310 has predicted that the boundary of the mobile machine 100 will change (e.g., the width of the mobile machine 100 will change). This may be because logistics system 310 predicts that the mobile machine 100 will change the position of or deploy a component of the mobile machine 100 at PTₙ₋₁ (e.g., logistics system 310 predicts that mobile harvesting machine 100-1 will change the position of or deploy an unloading auger for a material transfer operation).

While dynamic boundary 500-1 indicates the boundary of a mobile machine 100 in two dimensions (e.g., width and length) it will be understood that in other examples a dynamic boundary 500 can indicate the boundary of a mobile machine 100 in three dimensions (e.g., width, length, and height).

FIG. 4B shows a side, pictorial view of an example dynamic boundary 500-2 that corresponds to a mobile machine 100, such as a mobile harvesting machine 100-1. As can be seen, dynamic boundary 500-2 includes a historic portion 502-2 that indicates timestamped (shown as historic timestamps HTₙ₋₁ and HTₙ₋₂), historic geographic positions and historic boundaries of the mobile machine 100 as well as the historic path of the mobile machine 100. Dynamic boundary 500-2 further includes a current portion 504-2 that indicates a timestamped (shown as current timestamp CT), current geographic position and current boundary of the mobile machine 100. Dynamic boundary 500-2 further includes a future predictive portion 506-2 that indicates timestamped (shown as predictive timestamps PTₙ₋₁ and PTₙ₋₂), future predictive geographic positions and future predictive boundaries of the mobile machine 100, as well as the future predictive path of the mobile machine 100. As can be seen in FIG. 4B, at predictive timestamp (or time) PTₙ₋₁ logistics system 310 has predicted that the boundary of the mobile machine 100 will change (e.g., the height of the mobile machine 100 will change). This may be because logistics system 310 predicts that the mobile machine 100 will change the position of or deploy a component of the mobile machine 100 at PTₙ₋₁ (e.g., logistics system 310 predicts that mobile harvesting machine 100-1 will change the position of or deploy (e.g., open) a grain tank cover).

While dynamic boundary 500-2 indicates the boundary of a mobile machine 100 in two dimensions (e.g., height and length) it will be understood that in other examples a dynamic boundary 500 can indicate the boundary of a mobile machine 100 in three dimensions (e.g., width, length, and height).

In some examples, it will be understood that an output dynamic boundary corresponding to a mobile machine 100 can indicate the boundary of the mobile machine 100 in three dimensions using multiple two-dimensional presentable forms, such as a first presentable form that indicates the boundary of the mobile machine 100 along the length and width of the mobile machine 100 and a second presentable form that indicates the boundary of the mobile machine 100 along its height and length. The first and second presentable forms can be presented simultaneously. In another example, an output dynamic boundary can indicate the boundary of the mobile machine 100 in three dimensions using a single presentable form (e.g., a cuboid) that indicates the boundary of the mobile machine along the length, width, and height of the mobile machine 100.

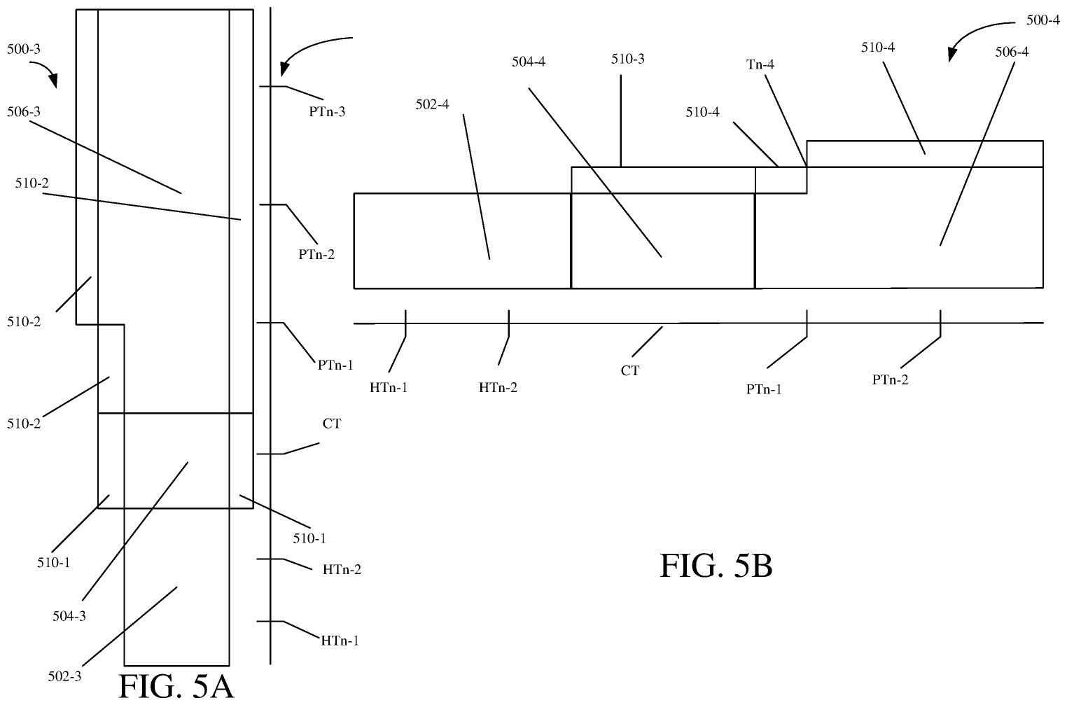

FIGS. 5A-5B are pictorial illustrations showing example logistics outputs 350 generated by logistics system 310. FIGS. 5A-5B shows that a logistics output 350 can include a dynamic boundary 500 and a corresponding confidence band 510. As illustrated, a dynamic boundary 500 can include a historical portion 502, a current portion 504, and a future portion 506. Additionally, as illustrated, a confidence band 510 can be generated and correspond to each of current portion 504 and future portion 506. It will be understood that the examples shown in FIGS. 5A-5B illustrate examples of dynamic boundaries and confidence bands output by logistics system 310 in a presentable form (e.g., as a displayable element). In other examples, it will be understood that the dynamic boundaries and confidence bands output by logistics system 310 need not be in a presentable form such as the ones shown in FIGS. 5A-5B. For example, a dynamic boundary can instead include timestamped values indicating the location and boundary of a mobile machine 100 at each of a plurality of different timestamps (e.g., a geographic position value and x, y, and z values at each time stamp). A confidence band, for example, can instead include timestamped values indicating a range of the location and boundary of a mobile machine 100 at each of plurality of different timestamps (e.g., a range of geographic position values and a range of x, y, and z values at each time stamp).

FIG. 5A shows a top, pictorial view of an example dynamic boundary 500-3 and a corresponding confidence band 510. Dynamic boundary 500-3 includes a historic portion 502-3 that indicates timestamped (shown as historic timestamps HTₙ₋₁ and HTₙ₋₂), historic geographic positions and historic boundaries of the mobile machine 100 as well as the historic path of the mobile machine 100. Dynamic boundary 500-3 further includes a current portion 504-3 that indicates a timestamped (shown as current timestamp CT), current geographic position and current boundary of the mobile machine 100. Dynamic boundary 500-3 further includes a future predictive portion 506-3 that indicates timestamped (shown as predictive timestamps PTₙ₋₁, PTₙ₋₂, and PTₙ₋₃), future predictive geographic positions and future predictive boundaries of the mobile machine 100, as well as the future predictive path of the mobile machine 100. As can be seen in FIG. 5A, at predictive timestamp (or time) PTₙ₋₁ logistics system 310 has predicted that the boundary of the mobile machine 100 will change (e.g., the width of the mobile machine 100 will change). This may be because logistics system 310 predicts that the mobile machine 100 will change the position of or deploy a component of the mobile machine 100 at PTₙ₋₁ (e.g., logistics system 310 predicts that mobile harvesting machine 100-1 will change the position of or deploy an unloading auger for a material transfer operation). Additionally, as illustrated, confidence band 510 includes a current confidence band portion 510-1 that corresponds to current portion 504-3 of dynamic boundary 500-3 as well as a future predictive confidence band portion 510-2 that corresponds to future predictive portion 506-3 of dynamic boundary 500-3. It can be seen that confidence band 510 represents a range of boundary and location values for each of a plurality of timestamps and thus effectively extends the boundary of the mobile machine 100.

While dynamic boundary 500-3 and confidence band 510, in FIG. 5A, indicate the boundary and range of the boundary, respectively, of a mobile machine 100 in two dimensions (e.g., width and length) it will be understood that in other examples a dynamic boundary 500 can indicate the boundary of a mobile machine 100 in three dimensions (e.g., width, length, and height) and the corresponding confidence band 510 can indicate the range of the boundary in three dimensions (e.g., width, length, and height).

FIG. 5B shows a side, pictorial view of an example dynamic boundary 500-4 and a corresponding confidence band 510. Dynamic boundary 500-4 includes a historic portion 502-4 that indicates timestamped (shown as historic timestamps HTₙ₋₁ and HTₙ₋₂), historic geographic positions and historic boundaries of the mobile machine 100 as well as the historic path of the mobile machine 100. Dynamic boundary 500-4 further includes a current portion 504-4 that indicates a timestamped (shown as current timestamp CT), current geographic position and current boundary of the mobile machine 100. Dynamic boundary 500-4 further includes a future predictive portion 506-4 that indicates timestamped (shown as predictive timestamps PTₙ₋₁ and PTₙ₋₂), future predictive geographic positions and future predictive boundaries of the mobile machine 100, as well as the future predictive path of the mobile machine 100. As can be seen in FIG. 5B, at timestamp (or time) PTₙ₋₁ logistics system 310 has predicted that the boundary of the mobile machine 100 will change (e.g., the height of the mobile machine 100 will change). This may be because logistics system 310 predicts that the mobile machine 100 will change the position of or deploy a component of the mobile machine 100 at PTₙ₋₁ (e.g., logistics system 310 predicts that mobile harvesting machine 100-1 will change the position of or deploy (e.g., open) a grain tank cover). Additionally, as illustrated, confidence band 510 includes a current confidence band portion 510-3 that corresponds to current portion 504-4 of dynamic boundary 500-4 as well as a future predictive confidence band portion 510-4 that corresponds to future predictive portion 506-4 of dynamic boundary 500-4. It can be seen that confidence band 510 represents a range of boundary and location values for each of a plurality of timestamps and thus effectively extends the boundary of the mobile machine 100.

While dynamic boundary 500-4 and confidence band 510, in FIG. 5B, indicate the boundary and range of the boundary, respectively, of a mobile machine 100 in two dimensions (e.g., width and length) it will be understood that in other examples a dynamic boundary 500 can indicate the boundary of a mobile machine 100 in three dimensions (e.g., width, length, and height) and the corresponding confidence band 510 can indicate the range of the boundary in three dimensions (e.g., width, length, and height). 2

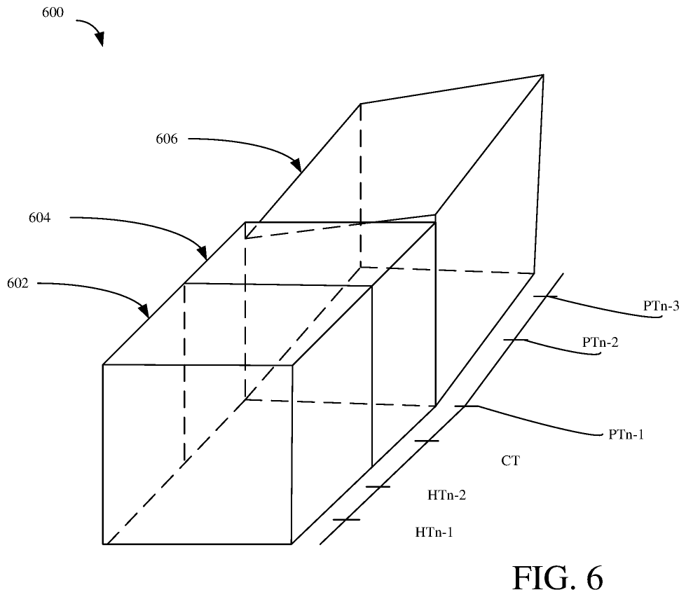

FIG. 6 is a pictorial illustration showing an example logistics output 350 generated by logistics system 310. FIG. 6 shows that a logistics output 350 can include a dynamic boundary 600. It will be understood that the example shown in FIG. 6 illustrates examples of a dynamic boundary output by logistics system 310 in a presentable form (e.g., as a displayable element). In other examples, it will be understood that the dynamic boundaries output by logistics system 310 need not be in a presentable form such as the one shown in FIG. 6 and can instead include timestamped values indicating the location and boundary of a mobile machine 100 at each of a plurality of different timestamps (e.g., a geographic position value and x, y, and z values at each time stamp).

As shown in FIG. 6, dynamic boundary 600 illustrates the location of a corresponding mobile machine 100 and the boundary of the corresponding mobile machine 100 at each of a plurality of times. It can be seen, in FIG. 6, that dynamic boundary 600 indicates the boundary of the corresponding mobile machine 100 in three dimensions (width, length, and height). As illustrated, a dynamic boundary 600 can include a historical portion 602, a current portion 604, and a future predictive portion 606. Historic portion 602 indicates timestamped (shown as historic timestamps HTₙ₋₁ and HTₙ₋₂), historic geographic positions and historic boundaries of the mobile machine 100 as well as the historic path of mobile machine 100. Current portion 604 indicates a timestamped (shown as current timestamp CT), current geographic position and current boundary of the mobile machine 100. Future predictive portion 606 indicates timestamped (shown as predictive timestamps PTₙ₋₁, PTₙ₋₂, and PTₙ₋₃), future predictive geographic positions and future predictive boundaries of the mobile machine 100, as well as the future predictive path of the mobile machine 100. As can be seen in FIG. 6, at predictive timestamp (or time) PTₙ₋₁ logistics system 310 has predicted that the boundary of the mobile machine 100 will change (e.g., logistics system 310 predicts that the mobile machine 100 will roll at PTₙ₋₁ causing a corresponding change in the boundary of the mobile machine 100). Characteristics of the terrain of the worksite, such as slope, surface smoothness, bumps and dips, etc. can have an effect on the orientation of the mobile machine 100 and thus the boundary of the mobile machine 100.

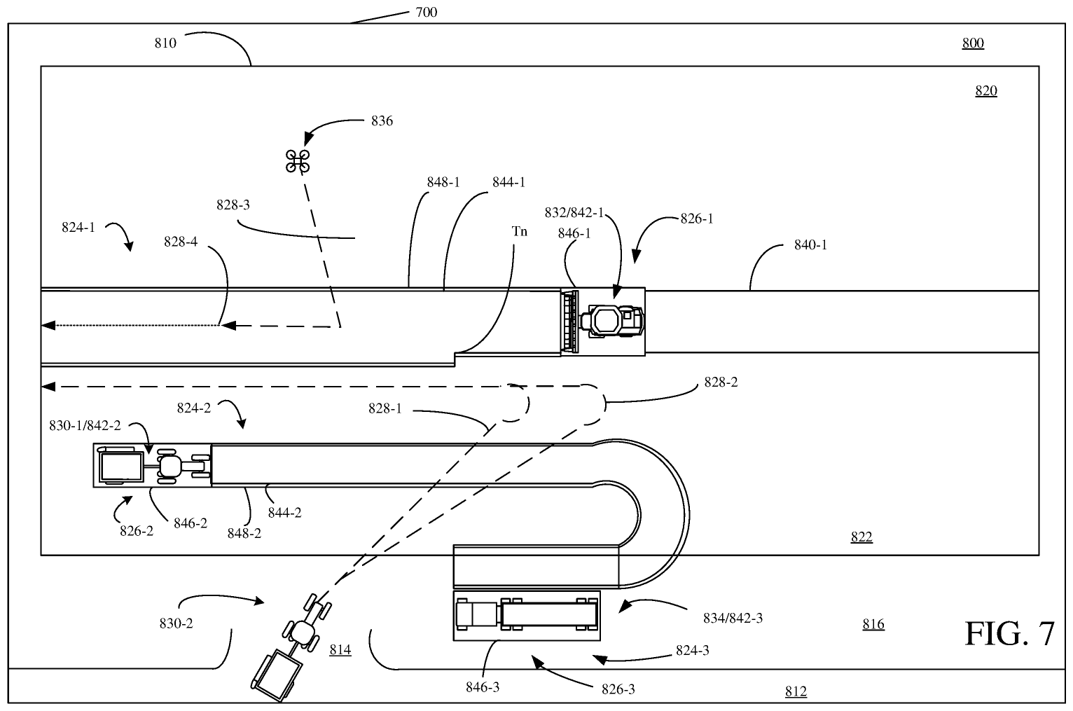

FIG. 7 is a pictorial illustration showing an example logistics output 350 generated by logistics system 310. FIG. 7 shows that a logistics output can include a map 700 of the worksite. Map 700 includes a worksite display portion 800, representative of a worksite, that includes a field display portion 810, representative of a field, a travel way display portion 812, representative of a travel way (e.g., a road, a trail, etc.), a field entrance display portion 814, representative of a field entrance, restricted zone display icons 820, representative of a restricted zone, permitted zone display icon 822, representative of a permitted zone, dynamic boundary display icons 824, representative of dynamic boundaries, confidence band display icons 826, route display icons 828, and mobile machine display icons 830, 832, 834, and 836, representative of mobile machines. The display portions and icons are displayed, in the map 700, at their corresponding geographic locations in the worksite portrayed by the map 700. A dynamic boundary display icon 824, itself, can include a historical portion display icon 840, a current portion display icon 842, and a future predictive portion display icon 844. A confidence band display icon 826, itself, can include a current confidence band portion icon 846 and a future predictive confidence band portion 848.

As can be seen in FIG. 7, the map 700 illustrates a harvesting operation in which multiple mobile machines are operating, including a harvesting machine 100-1 as represented by display icon 832, multiple towed grain carts 100-2 as represented by display icons 830-1 and 830-2, a towed trailer 100-3 as represented by icon 834, and a UAV as represented by icon 836.

A dynamic boundary has been generated and displayed for multiple mobile machines. As shown, a dynamic boundary for a harvesting machine 100-1 has been generated and displayed as indicated by dynamic boundary display icon 824-1. Dynamic boundary display icon 824-1 includes historical portion display icon 840-1 (representing a historical travel path and historical boundary of the harvester 100-1), current portion display icon 842-1 (representing a current location and current boundary of harvester 100-1), and future predictive portion display icon 844-1 (representing a future predictive travel path and future predictive boundary of harvester 100-1). It will be understood that in the illustrated example, the current portion display icon 842-1 is also the mobile machine display icon 832, though in other examples, they could be separate. Additionally, as shown, a dynamic boundary for a towed grain cart 100-2 has been generated and displayed as indicated by dynamic boundary display icon 824-2. Dynamic boundary display icon 824-2 includes current portion display icon 842-2 (representing a current location and current boundary of the towed grain cart 100-2) and future predictive portion display icon 844-2 (representing a future predictive travel path and future predictive boundary of the towed grain cart 100-2). In other examples, the dynamic boundary display icon 824-2 could also include a historical portion display icon representing a historical travel path and historical boundary of the towed grain cart 100-2. It will be understood that in the illustrated example, the current portion display icon 842-2 is also the mobile machine display icon 830-1, though in other examples, they could be separate. Additionally, as shown, a dynamic boundary for a towed trailer 100-3 has been generated and displayed as indicated by dynamic boundary display icon 824-3. Dynamic boundary display icon 824-3 includes current portion display icon 842-3 (representing a current location and current boundary of the towed trailer 100-3). In other examples, the dynamic boundary display icon 824-3 could also include a historical portion display icon representing a historical travel path and boundary of the towed trailer 100-3 and a future predictive portion display icon representing a future predictive travel path and future predictive boundary of the towed trailer 100-3. It will be understood that in the illustrated example, the current portion display icon 842-3 is also the mobile machine display icon 834, though in other examples, they could be separate.

As shown in FIG. 7, a confidence band has been generated and displayed for multiple mobile machines. As shown, a confidence band for a harvesting machine 100-1 has been generated and displayed as indicated by confidence band display icon 826-1. Confidence band display icon 826-1 includes a current confidence band portion icon 846-1 (representing a confidence band corresponding to the current portion of the dynamic boundary of the harvesting machine 100-1) and a future predictive confidence band portion 848-1 (representing a confidence band corresponding to the future predictive portion of the dynamic boundary of the harvesting machine 100-1). Additionally, as shown, a confidence band for a towed grain cart 100-2 has been generated and displayed as indicated by confidence band display icon 826-2. Confidence band display icon 826-2 includes a current confidence band portion icon 846-2 (representing a confidence band corresponding to the current portion of the dynamic boundary of the towed grain cart 100-2) and a future predictive confidence band portion 848-2 (representing a confidence band corresponding to the future predictive portion of the dynamic boundary of the towed grain cart 100-2). Additionally, as shown, a confidence band for a towed trailer 100-3 has been generated and displayed as indicated by confidence band display icon 826-3. Confidence band display icon 826-3 includes a current confidence band portion icon 846-3 (representing a confidence band corresponding to the current portion of the dynamic boundary of the towed trailer 100-3). In other examples, the confidence band display icon 826-3 could also include a future predictive confidence band portion representing a confidence band corresponding to the future predictive portion of the dynamic boundary of the towed trailer 100-3. 3

As can be seen in FIG. 7, a towed grain cart 100-2 (represented by icon 830-2) is attempting to travel on the field and rendezvous with the harvesting machine 100-1 (represented by icon 832) to perform a material transfer operation (unloading of grain from the harvesting machine 100-1 to the towed grain cart 100-2). Without a logistics system 310, an operator (human or automated control system) may have utilized a route 828-1 to guide the towed grain cart 100-2 wherein it may have interfered with another towed grain cart 100-2 (represented by icon 830-1). However, with logistics system 310, a route 828-2 can be generated and utilized (based at least on the dynamic boundary and confidence band corresponding to the towed grain cart 100-2 represented by icon 830-1) to control the travel of the towed grain cart 100-2 (represented by icon 830-2) such that it does not interfere with another mobile machine. For instance, the route 828-2 may prevent the two towed grain carts 100-2 from traveling at the same location at the same time, as may occur with route 828-1 (at least given a current travel speed setting). In another example, instead of generating an alternative route, logistics system 310 may retain route 828-1 and instead alter the travel speed of the towed grain cart 100-2 (represented by icon 830-2) along route 828-1 such that it does not interfere with another machine.

Additionally, as can be seen in FIG. 7, a UAV 100-4 (represented by icon 836) is attempting to travel on the field and observe a material transfer operation between a harvester 100-1 (represented by icon 832) and a towed grain cart 100-2 (represented by icon 830-2). Without logistics system 310, an operator (human or automated control system) may have utilized a route 828-3 to guide the UAV 100-4 wherein it may have interfered with the harvesting machine 100-1. However, with logistics system 310, a route 828-4 can be generated and utilized (based at least on the dynamic boundary and confidence band corresponding to the harvesting machine 100-1 represented by icon 832) to control the travel of the UAV 100-4 such that it does not interfere with another mobile machine. For instance, the route 828-4 may increase the altitude of the UAV 100-4 to account for a change in the boundary of the harvesting machine 100-1 (e.g., an increase in height) at that location. The change in boundary is indicated by the dynamic boundary corresponding to the harvesting machine 100-1.

It will be noted that the designation of a restricted zone and a permitted zone may change depending on the system that the output (e.g., map) is provided to. In the illustrated example, the map 700 is provided to an operator of a towed grain cart 100-2 and thus the restricted zone represented by icon 820 exists as it corresponds to an unharvested area of the field upon which travel of a towed grain cart 100-2 is undesired. However, in another example in which the map 700 is provided to an operator of a UAV 100-4 the restricted zone represented by icon 820 may not exist as a UAV 100-4 can travel above, and thus not interfere with, unharvested crop.

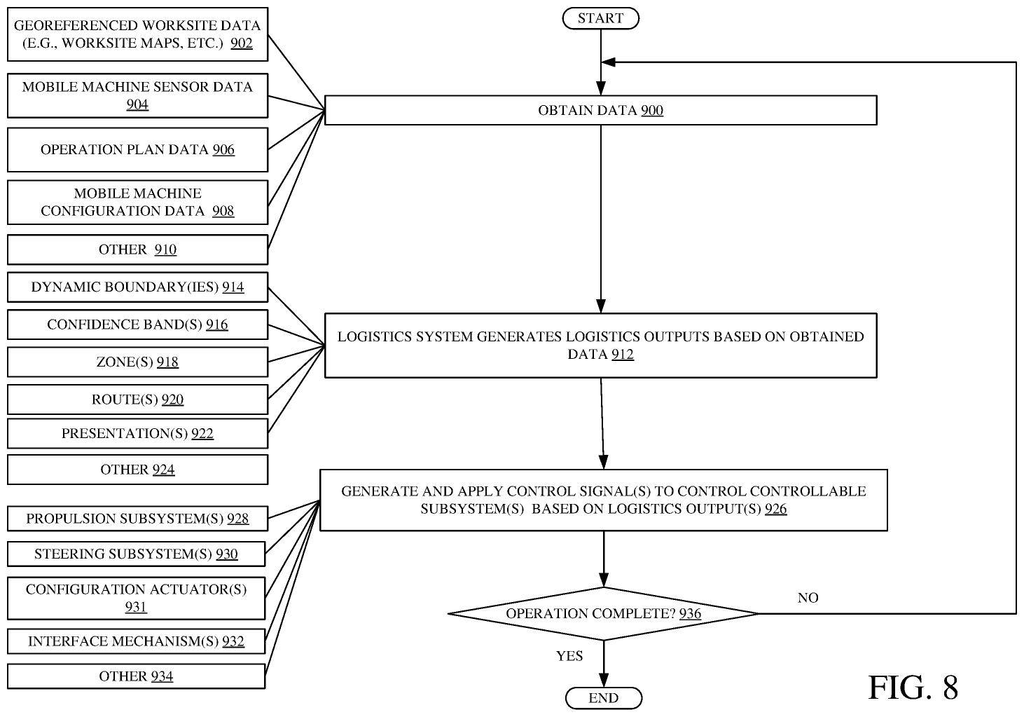

FIG. 8 is a flowchart showing one example operation of logistics system 310. At block 900 it is assumed that a worksite operation is underway, though, in other examples, the operation of logistics system 310, or a portion of the operation of logistics system 310, can take place prior to the worksite operation being underway or after the worksite operation has been completed. At block 900, various data is obtained (e.g., retrieved or received) by logistics system 310. Such data can include georeferenced worksite data 502, as indicated by block 902. Alternatively, or additionally, such data can include mobile machine sensor data 504, as indicated by block 904. Alternatively, or additionally, such data can include operation plan data 506, as indicated by block 906. Alternatively, or additionally, such data can include mobile machine configuration data 508, as indicated by block 908. Alternatively, or additionally, such data can include various other data 510, as indicated by block 910.

At block 912, logistics system 310 generates one or more logistics outputs 350 based on the data obtained at block 900. The one or more logistics outputs 350 can include one or more dynamic boundaries, as indicated by block 914. Alternatively, or additionally, the one or more logistics outputs 350 can include one or more confidence bands, as indicated by block 916. Alternatively, or additionally, the one or more logistics outputs 350 can include one or more zones (e.g., one or more restricted zones or one or more permitted zones, or both), as indicated by block 918. Alternatively, or additionally, the one or more logistics outputs 350 can include one or more routes as indicated by block 920. Alternatively, or additionally, the one or more logistics outputs 350 can include one or more presentations, as indicated by block 922. Alternatively, or additionally, the one or more logistics outputs 350 can include one or more other items, as indicated by block 924.

At block 926, each of one or more control systems 414 generates and applies one or more control signals to control one or more controllable subsystems (e.g., 416 or 418, or both) of a respective mobile machine 100 based on the one or more logistics outputs 350 generated by logistics system 310. The one or more control signals can include one or more control signals to control a propulsion subsystem 450 of a respective mobile machine 100, as indicated by block 928. Alternatively, or additionally, the one or more control signals can include one or more control signals to control a steering subsystem 452 of a respective mobile machine 100, as indicated by block 930. Alternatively, or additionally, the one or more control signals can include one or more control signals to control one or more configuration actuators 454 of a respective mobile machine 100, as indicated by block 931. Alternatively, or additionally, the one or more control signals can include one or more control signals to control one or more interface mechanisms 418 of a respective mobile machine 100, as indicated by block 932. Alternatively, or additionally, the one or more control signals can include one or more control signals to control one or more other items (e.g., other controllable subsystems 456), as indicated by block 934.

At block 936 it is determined if the worksite operation has been completed. If, at block 936, it is determined that the worksite operation has not been completed, then processing returns to block 900. If at block 936, it is determined that the worksite operation has been completed, then processing ends.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores May be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, components, generators, and interactions. It will be appreciated that any or all of such systems, components, generators, and interactions may be implemented by hardware items, such as one or more processors, one or more processors executing computer executable instructions stored in memory, memory, or other processing components, some of which are described below, that perform the functions associated with those systems, components, generators, or interactions. In addition, any or all of the systems, components, generators, and interactions may be implemented by software that is loaded into a memory and is subsequently executed by one or more processors or one or more servers or other computing component(s), as described below. Any or all of the systems, components, generators, and interactions may also be implemented by different combinations of hardware, software, firmware, etc., some examples of which are described below. These are some examples of different structures that may be used to implement any or all of the systems, components, generators, and interactions described above. Other structures may be used as well.

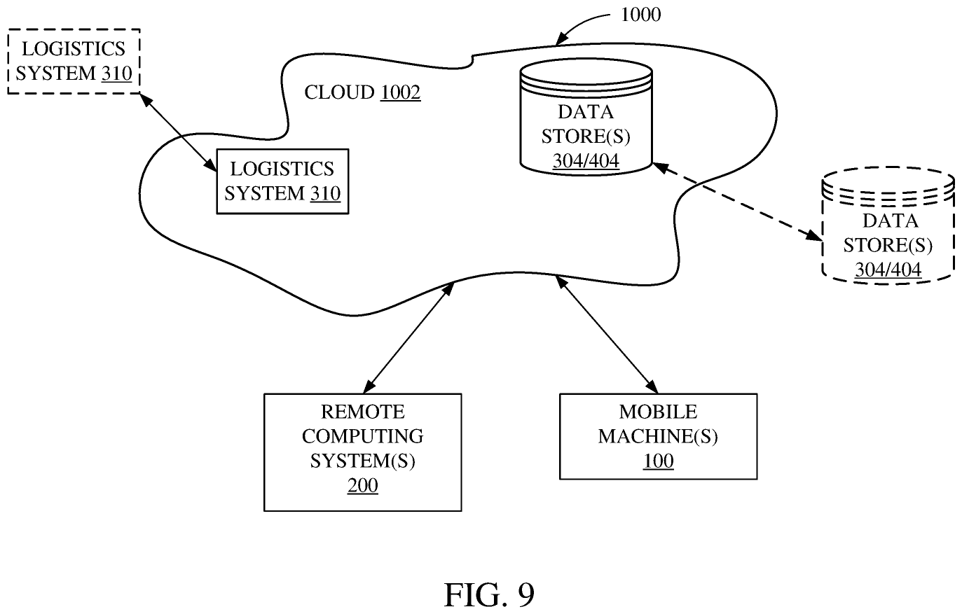

FIG. 9 is a block diagram of a remote server architecture 1000. FIG. 9, also shows one or more mobile machines 100 and one or more remote computing systems 200 in communication with the remote server environment. The mobile machines 100 and remote computing systems 200 communicate with elements in a remote server architecture 1000. In some examples, remote server architecture 1000 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in previous figures as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 9, some items are similar to those shown in previous figures and those items are similarly numbered. FIG. 9 specifically shows that logistics system 310, data stores 304, or data stores 404, or a combination thereof may be located at a server location 1002 that is remote from the mobile machines and the remote computing systems 200. Therefore, in the example shown in FIG. 9, mobile machines 100 and remote computing systems 200 accesses systems through remote server location 1002. In other examples, various other items may also be located at server location 1002, such as various other items of worksite operation system architecture 300.

FIG. 9 also depicts another example of a remote server architecture. FIG. 9 shows that some elements of previous figures may be disposed at a remote server location 1002 while others may be located elsewhere. By way of example, one or more of data store(s) 304 and 404 may be disposed at a location separate from location 1002 and accessed via the remote server at location 1002. Similarly, logistics system 310 may be disposed at a location separate from locations 1002 and accessed via the remote server at locations 1002. Regardless of where the elements are located, the elements can be accessed directly by mobile machines 100 and remote computing systems 200 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users or systems. For instance, physical carriers may be used instead of, or in addition to, electromagnetic wave carriers. In some examples, where wireless telecommunication service coverage is poor or nonexistent, another machine, such as a fuel truck or other mobile machine or vehicle, may have an automated, semi-automated or manual information collection system. As a mobile machine 100 comes close to the machine containing the information collection system, such as a fuel truck prior to fueling, the information collection system collects the information from the mobile machine 100 using any type of ad-hoc wireless connection. The collected information may then be forwarded to another network when the machine containing the received information reaches a location where wireless telecommunication service coverage or other wireless coverage-is available. For instance, a fuel truck may enter an area having wireless communication coverage when traveling to a location to fuel other machines or when at a main fuel storage location. All of these architectures are contemplated herein. Further, the information may be stored on a mobile machine 100 until the mobile machine 100 enters an area having wireless communication coverage. The mobile machine 100, itself, may send the information to another network.

It will also be noted that the elements of previous figures, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

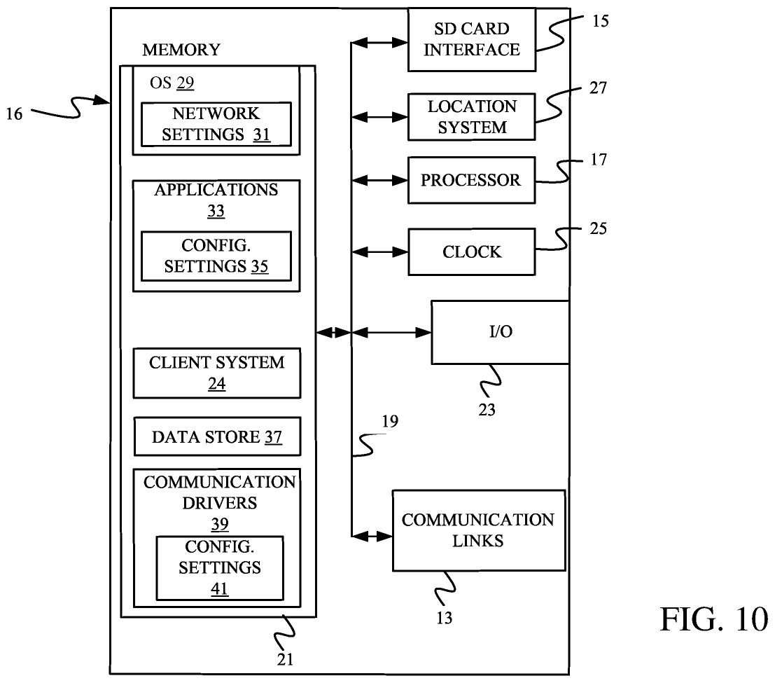

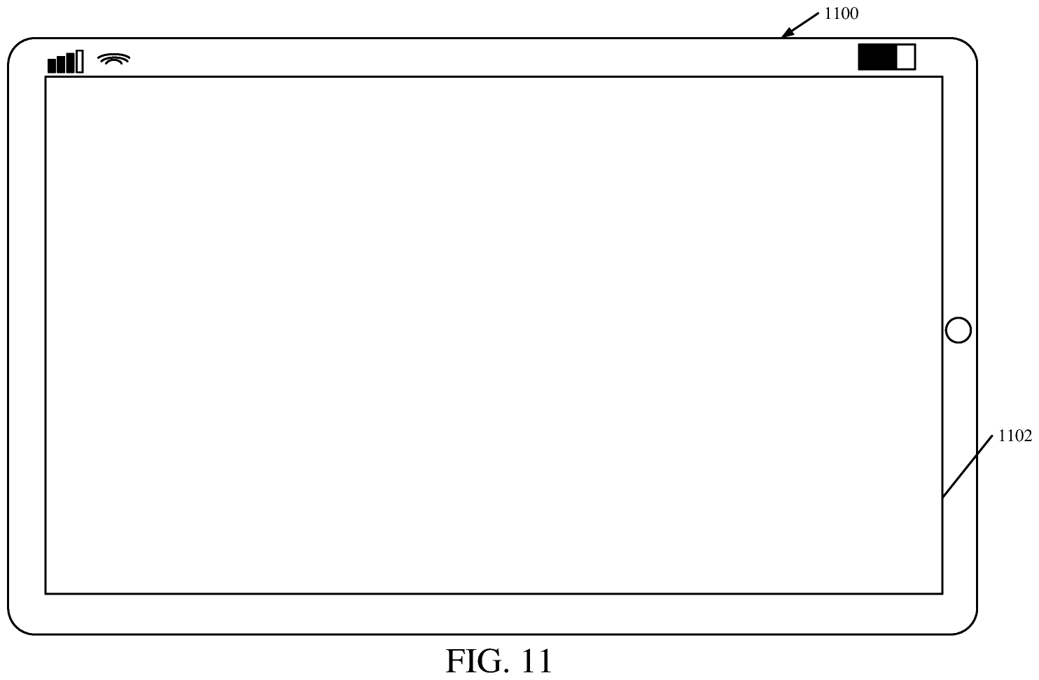

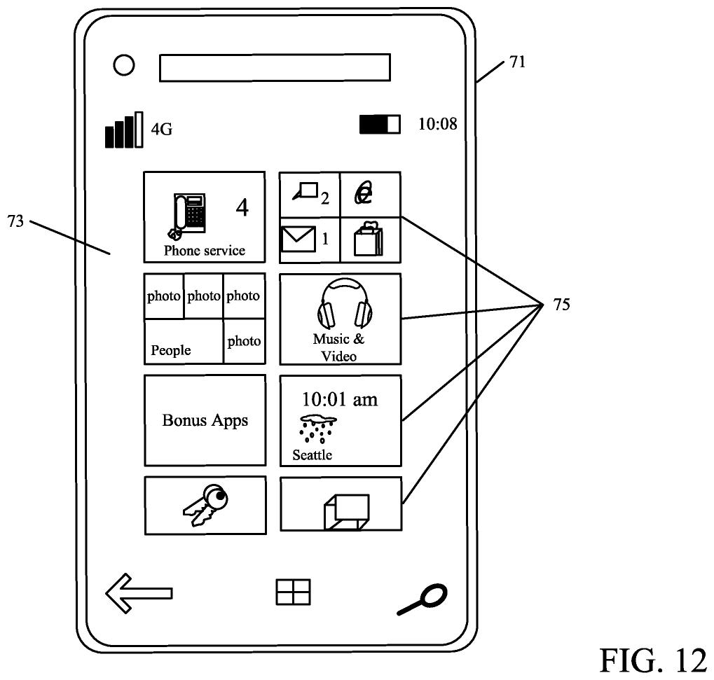

FIG. 10 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine 100 for use in generating, processing, or displaying the logistics outputs discussed above. FIGS. 11-12 are examples of handheld or mobile devices.

FIG. 10 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 may also include computer storage media (described below). Memory 21 stores computer readable instructions that, when executed by processor 17, cause the processor to perform computer-implemented steps or functions according to the instructions. Processor 17 may be activated by other components to facilitate their functionality as well.

FIG. 11 shows one example in which device 16 is a tablet computer 1100. In FIG. 11, computer 1100 is shown with user interface display screen 1102. Screen 1102 can be a touch screen or a pen-enabled interface that receives inputs from a pen or stylus. Tablet computer 1100, May also use an on-screen virtual keyboard. Of course, computer 1100 might also be attached to a keyboard or other user input device through a suitable attachment mechanism, such as a wireless link or USB port, for instance. Computer 1100 may also illustratively receive voice inputs as well.

FIG. 12 is similar to FIG. 11 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

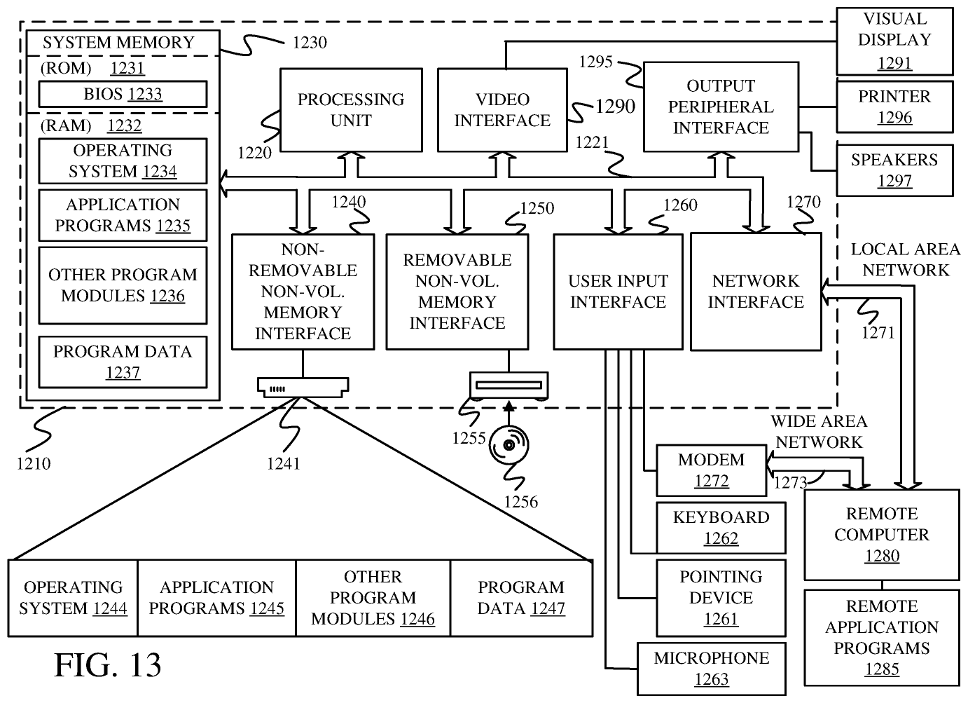

FIG. 13 is one example of a computing environment in which elements of previous figures described herein can be deployed. With reference to FIG. 13, an example system for implementing some embodiments includes a computing device in the form of a computer 1210 programmed to operate as discussed above. Components of computer 1210 may include, but are not limited to, a processing unit 1220 (which can comprise processors or servers from previous figures), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to previous figures described herein can be deployed in corresponding portions of FIG. 13.

Computer 1210 typically includes a variety of computer readable media. Computer readable media may be any available media that can be accessed by computer 1210 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means 11 a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 13 illustrates operating system 1234, application programs 1235, other program modules 1236, and program data 1237.

The computer 1210 may also include other removable/non-removable volatile/nonvolatile computer storage media. By way of example only, FIG. 13 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1210. In FIG. 13, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite dish, scanner, or the like. These and other input devices are often connected to the processing unit 1220 through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections (such as a controller area network—CAN, local area network—LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 13 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

What is claimed is:

1. A worksite operation system comprising:
one or more processors; and
a data store configured to store computer executable instructions that, when executed by the one or more processors, configure the one or more processors to:
obtain data, the data including machine sensor data indicative of one or more characteristics of a first mobile machine operating at a worksite;
generate, based on the obtained data, a dynamic boundary output corresponding to the first mobile machine, the dynamic boundary output indicative of a predictive boundary of the first mobile machine at a location along a predictive path of the first mobile machine at the worksite; and
generate a control signal based on the dynamic boundary output corresponding to the first mobile machine.

2. The worksite operation system of claim 1, wherein the control signal controls a second mobile machine.

3. The worksite operation system of claim 2, wherein the first mobile machine comprises a ground-based mobile machine and the second mobile machine comprises an aerial mobile machine.

4. The worksite operation system of claim 1, wherein the dynamic boundary output corresponding to the first mobile machine is indicative of the predictive boundary of the first mobile machine at the location along the predictive path of the first mobile machine at the worksite in three dimensions.

5. The worksite operation system of claim 1, wherein the computer executable instructions, when executed by the one or more processors, further configure the one or more processors to:
generate a confidence band corresponding to the dynamic boundary output, the confidence band surrounding an area of the worksite to which the predictive boundary of the first mobile machine corresponds; and
generate the control signal based further on the confidence band.

6. The worksite operation system of claim 4, wherein the computer executable instructions, when executed by the one or more processors, further configure the one or more processors to:
generate a permitted zone corresponding to an area of the worksite and a restricted zone corresponding to an area of the worksite based on the dynamic boundary output; and
generate the control signal based further on the permitted zone and the restricted zone.

7. The worksite operation system of claim 1, wherein the computer executable instructions, when executed by the one or more processors, further configure the one or more processors to:
generate a route based on the dynamic predictive boundary output; and
generate the control signal to control a heading of a second mobile machine based on the route.

8. The worksite operation system of claim 1, wherein the control signal controls a travel speed of a second mobile machine.

9. The worksite operation system of claim 1, wherein the data further includes one or more of:
georeferenced worksite data indicative of one or more georeferenced characteristics of the worksite;
machine configuration data indicative of one or more configuration characteristics of the first mobile machine operating at the worksite; or
machine operation data indicative of one or more characteristics of an operation being performed by the first mobile machine at the worksite.

10. The worksite operation system of claim 1, wherein the dynamic boundary output further indicates a current boundary of the first mobile machine at a current location of the first mobile machine.

11. The worksite operation system of claim 10, wherein the dynamic boundary output further indicates a historical boundary at a location along a historical path of the first mobile machine at the worksite.

12. The worksite operation system of claim 10, wherein the control signal controls a position of a component of the first mobile machine or a position of a component of a second mobile machine.

13. A computer implemented method of controlling a worksite operation, the computer implemented method comprising:
obtaining data indicative of one or more characteristics of a first mobile machine operating at the worksite;
generating, based on the obtained data, a dynamic boundary output corresponding to the first mobile machine, the dynamic boundary output indicative of a future predictive boundary of the first mobile machine at a location along a future predictive path of the first mobile machine at the worksite; and
controlling a second mobile machine to perform the worksite operation based on the dynamic boundary output corresponding to the first mobile machine.

14. The computer implemented method of claim 13, wherein generating the dynamic boundary output comprises generating the dynamic boundary output in three dimensions.

15. The computer implemented method of claim 13, wherein controlling the second mobile machine comprises controlling a travel path of the second mobile machine.

16. The computer implemented method of claim 13, wherein controlling the second mobile machine comprises controlling a travel speed of the second mobile machine.

17. The computer implemented method of claim 13 and further comprising:
generating a map of the worksite, the map including a display element indicating the first mobile machine and a display element indicating the dynamic boundary output; and
controlling an interface mechanism to display the map of the worksite.

18. The computer implemented method of claim 17, wherein obtaining data indicative of one or more characteristic of the first mobile machine operating at the worksite comprises obtaining one or more of machine sensor data indicative of one or more sensed characteristics of the first mobile machine, machine configuration data indicative of one or more configuration characteristics of the first mobile machine, georeferenced worksite data indicative of one or more georeferenced characteristics of the worksite, or machine operation plan data indicative of one or more characteristics of an operation being performed by the first mobile machine at the worksite, the method further comprising:
generating a confidence band corresponding to the dynamic boundary output based on the obtained one or more of machine sensor data, machine configuration data, georeferenced worksite data, or machine operation plan data, the confidence band surrounding an area of the worksite to which the predictive boundary of the first mobile machine corresponds.

19. The computer implemented method of claim 13, wherein obtaining data indicative of one or more characteristics of the first mobile machine operating at the worksite comprises:
obtaining one or more of machine sensor data indicative of one or more sensed characteristics of the first mobile machine, machine configuration data, indicative of one or more configuration characteristics of the first mobile machine, georeferenced worksite data indicative of one or more georeferenced characteristics of the worksite, or operation plan data indicative of one or more characteristics of an operation being performed by the first mobile machine at the worksite.

20. A worksite operation system comprising:
one or more processors; and
a data store configured to store computer executable instructions that, when executed by the one or more processors, configured the one or more processors to:
obtain first data, the first data including first machine sensor data indicative of one or more characteristics of a first mobile machine operating at a worksite;
obtain second data, the second data including second machine sensor data indicative of one or more characteristics of a second mobile machine operating at the worksite;
generate, based on the obtained first data, a first dynamic boundary output corresponding to the first mobile machine, the first dynamic boundary output indicative of a future predictive boundary of the first mobile machine at a location along a future predictive path of the first mobile machine at the worksite;
generate, based on the obtained second data, a second dynamic boundary output corresponding to the second mobile machine, the second dynamic boundary output indicative of a future predictive boundary of the second mobile machine at a location along a future predictive path of the second mobile machine at the worksite; and
generate a control signal to control a third mobile machine based on at least one of the first dynamic boundary output corresponding to the first mobile machine or the second dynamic boundary output corresponding to the second mobile machine.
